(19) United States
(12) Patent Application Publication
(10) Pub. No.: US 2016/0236606 A1
(43) Pub. Date: Aug. 18, 2016

(54) METHOD FOR CONTROLLING HOISTING OF AN ARTICULATED MACHINE

(71) Applicant: Caterpillar Inc., Peoria, IL (US)

(72) Inventors: Timothy D. Schwartz, Metamora, IL (US); Ryan Thomas Anderson, Germantown Hills, IL (US); Rodney Lee Menold, Peoria, IL (US)

(73) Assignee: Caterpillar Inc., Peoria, IL (US)

(21) Appl. No.: 15/137,458

(22) Filed: Apr. 25, 2016

(51) Int. Cl. B60P 1/28; G05D 3/12; B60P 1/60

(52) U.S. Cl. CPC B60P 1/28; B60P 1/60; G05D 3/12

(57) ABSTRACT

A method of controlling an articulated machine having a first frame and a second frame and travelling on a ground surface is provided. The method includes receiving a speed signal indicative of a speed of the articulated machine through a speed sensor by a controller. The method includes receiving an inclination signal indicative of an inclination of the ground surface through an inclination sensor by the controller. The method further includes receiving a payload signal indicative of a payload carried by the articulated machine through a payload sensor by the controller. The controller controls a hoisting of the second frame with respect to the first frame based on at least one of the speed signal, the inclination signal and the payload signal.

### TECHNICAL FIELD

The present disclosure relates to an articulated machine, and more particularly to a system and a method of controlling a hoisting of the articulated machine.

### BACKGROUND

Articulated machines such as articulated trucks with a payload carrier, and ejector mechanisms typically include two frames such as a tractor unit and the payload carrier which is connected to the tractor unit via an articulation joint. The articulation joint enables the frames to roll and yaw with respect to each other.

Articulated machines are generally employed during construction and excavation and may be operated on uneven terrains. As a result, one of the frames may be positioned at an unsafe roll and/or yaw angle and may cause the entire machine to roll-over. Alternatively, if the articulated machine has an open container, such as an open carrier on one of the frame, any material in the container may fall out on uneven terrain if the machine operates beyond the maximum allowable operating speed, and safety limits of the roll and yaw angles. Furthermore, since the roll and yaw angles of the frames are independent of each other, the operator may be unaware of the unsafe roll and yaw angles which may result in possible roll over of the machine.

Hoisting the payload carrier when the articulated machine is either travelling on a grade, or beyond the safety limits of the roll and yaw angles or having a speed greater than a maximum operating speed limit may result in roll over of the articulated machine.

U.S. Pat. No. 7,236,096 discloses a monitoring system. The monitoring system of a dump truck prevents the raising of the cargo bed when the level of lateral tilt exceeds a safe limit, a keyed switch allows for presetting the maximum safe degree of tilt by simple left or right manipulation of the switch, and to switch the display from current level of left or right tilt to the value of the preset limit.

Hence, there is a need for improved control methods to control articulated machines.

### SUMMARY OF THE DISCLOSURE

In an aspect of the present disclosure, a method of controlling an articulated machine travelling on a ground surface is provided. The articulated machine includes a first frame and a second frame. The method includes receiving a speed signal indicative of a speed of the articulated machine through a speed sensor by the controller. The method includes receiving an inclination signal indicative of an inclination of the ground surface through an inclination sensor by the controller. The method further includes receiving a payload signal indicative of a payload being carried by the articulated machine through a payload sensor by the controller. Thereafter, the controller controls a hoisting of the second frame relative to the first frame based on at least one of the speed signal, the inclination signal and the payload signal.

### BRIEF DESCRIPTION OF THE DRAWINGS

FIG. 1 is a side view of an articulated machine in accordance with an embodiment of the present disclosure;

FIGS. 2 to 5 illustrate various orientations of the articulated machine in different operating conditions, in accordance with an embodiment of the present disclosure; and

FIG. 6 is block diagram illustrating the various inputs being received by a controller to control the articulated machine, in accordance with an embodiment of the present disclosure.

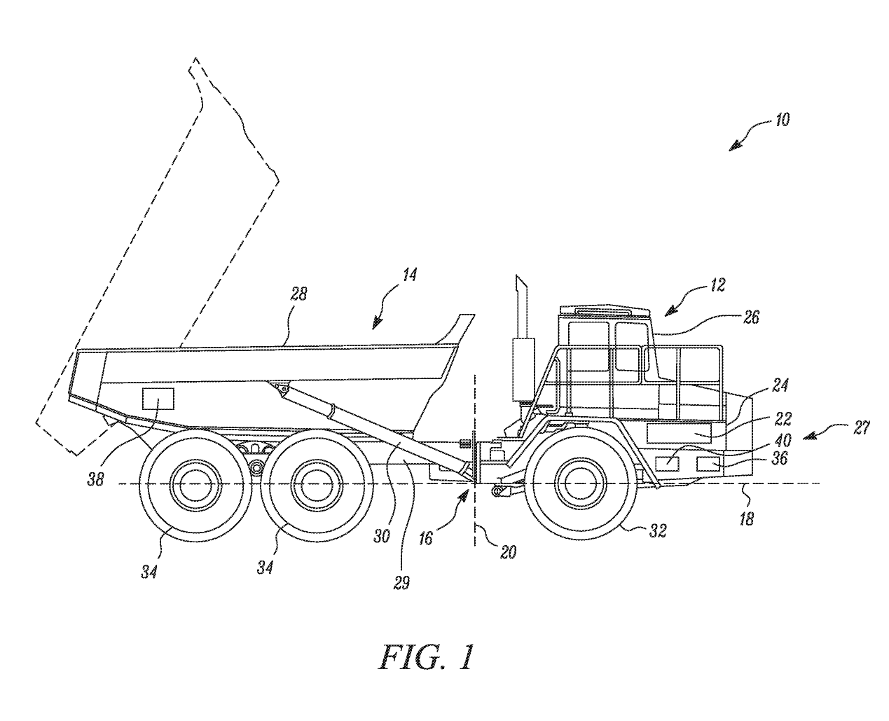

### DETAILED DESCRIPTION

Wherever possible, the same reference numbers will be used throughout the drawings to refer to the same or the like parts. The present disclosure relates to a system and method of controlling a hoisting of an articulated machine to prevent roll over of the articulated machine. FIG. 1 illustrates an exemplary machine 10 embodied as an articulated tipper truck. In various other embodiments, the machine 10 may be any other type of an articulated machine having a first frame 12 such as a tractor unit and a second frame 14 such as a payload carrier attached to the first frame 12 by a coupling assembly 16. The first frame 12 and the second frame 14 are moveable relative to each other in multiple directions. In an exemplary embodiment, the coupling assembly 16 may be an articulation joint.

The coupling assembly 16 may include a pivot frame coupling (not shown) and a rotational frame coupling (not shown). The pivot frame coupling provides articulated movement or pivoting of the second frame 14 relative to the first frame 12 about a central axis of articulation 18. The rotational frame coupling provides rotational movement of the second frame 14 relative to the first frame 12 about a longitudinal axis 20. The coupling assembly 16 may allow each of the first and second frames 12, 14 to be oriented at a different yaw angle and/or roll angle with respect to the central axis of articulation 18. The coupling assembly 16 may further include an actuation mechanism (not shown) configured to control the coupling assembly 16. In an exemplary aspect of the present disclosure, the actuation mechanism may be hydraulically, or electrically and/or electro-mechanically operated.

The machine 10 may further include an engine 22 positioned in an engine compartment 24 and supported on the first frame 12. The engine 22 may be an internal combustion engine, for example, a petrol engine, a diesel engine, or a gas powered engine. In the illustrated embodiment, an operator cab 26 is mounted on a front end 27 of the first frame 12 of the machine 10. The operator cab 26 may be located above the engine compartment 24 and extend rearward beyond the engine 22. In some embodiments, the operator cab 26 may enclose the engine 22 by forming a portion of the engine compartment 24. In other embodiments, the operator cab 26 may be pivotally mounted to the first frame 12, such that the operator cab 26 may be tilted to provide an access to the engine 22. The operator cab 26 houses various machine controls. The operator cab 26 may include a hoist control switch (not shown). The hoist control switch may be used by an operator of the machine 10 to command a hoist operation. The hoist control switch may be any type of a switch such as, but not limited to a push pull switch, a rotary switch, a knob switch etc.

The second frame 14 may include a body 28 such as the payload carrier for carrying a load. The body 28 is pivotally connected to a chassis 29 at a pivot point (not shown). During operation of the machine 10, the body 28 may be lowered or raised, such as to a raised position (shown in dashed lines) with respect to the first frame 12 of the machine 10 by an actuator 30. The actuator 30 is coupled between the chassis 29 and the second frame 14. The raised position of the second frame 14 is a tipping position where one end of the second frame 14 is raised from the chassis 29 and the other end remains on the chassis 29. Thus, the body 28 may eject out any material or the payload when in the raised position.

The second frame 14 may include an ejection mechanism (not shown) having an ejector plate (not shown) which slides horizontally from one end of an inside of the body 28 of the second frame 14 towards the other end. A hydraulic actuator or the like may be used to move the ejector plate towards the ejection end of the body 28 of the second frame 14. Further, a front wheel assembly 32 having a pair of front wheels is configured to provide rolling support to the operator cab 26 and is operably coupled to the first frame 12. A rear wheel assembly 34 is operably coupled to the second frame 14. The front wheel assembly 32 and the rear wheel assembly 34 are powered by the engine 22 via a drive train (not shown).

Further, the machine 10 may include a number of sensor assemblies associated with the machine 10. In an exemplary aspect of the present disclosure, the machine 10 may include a first sensor assembly 36 associated with the first frame 12 and a second sensor assembly 38 associated with the second frame 14. The first and second sensor assemblies 36, 38 are configured to provide a position information of the first and the second frames 12, 14 respectively. In an exemplary aspect of the present disclosure, the first sensor assembly 36 may act as a reference sensor. For example, the position information of the first and second frames 12, 14 may be a relative information of the respective frame with respect to the ground surface on which the machine 10 is operating.

The first sensor assembly 36 may be attached to any part of the first frame 12. The second sensor assembly 38 may be attached close to the pivot point between the body 28 and the chassis 29. In an exemplary embodiment of the present disclosure, the first and second sensor assemblies 36, 38 may include multi-axis inertia sensors configured to determine multi-axis position of the respective frames 12, 14. In various alternative embodiments, the first and second sensor assemblies 36, 38 may include any type of sensors capable of determining a pitch, a yaw and/or roll angle of the second frame 14 with respect to the first frame 12. For example, the first and second sensor assemblies 36, 38 may include accelerometer or gyroscope sensors. Further, the first and second sensor assemblies 36, 38 may include piezoelectric, capacitive, potentiometric, Hall Effect, magnetorestrictive or any other type microelectromechanical sensors.

Generally, the first and second sensor assemblies 36, 38 may include a “proof” mass which moves relative to the respective frames 12, 14. A difference in movement between the first and second frames 12, 14 and the proof mass is related to its acceleration and may be measured in a number of ways such as capacitively, piezo-electrically, and piezo-resistively. Further, the first and second sensor assemblies 36, 38 may measure linear acceleration in X, Y and Z directions and angular velocity about the X, Y and Z axis. Furthermore, the first and second sensor assemblies 36, 38 may be configured to provide output signals indicative of the position information of the respective frames 12, 14 of the machine 10 based on the measured linear acceleration and the angular velocity of the first and second frames 12, 14.

The machine 10 further includes a controller 40 (commonly known as an electronic control module or ECM) which controls various aspects of operational parameters of the machine 10. The output signals from the first and second sensor assemblies 36, 38 are transmitted to the controller 40 and used to calculate relative angles of the members to which the first and second sensor assemblies 36, 38 are attached, e.g. an angle of the body 28 relative to the first frame 12. The calculations may relate to both fore and aft angles (in the lateral direction of the machine 10) and side to side (across the transverse direction of the machine 10).

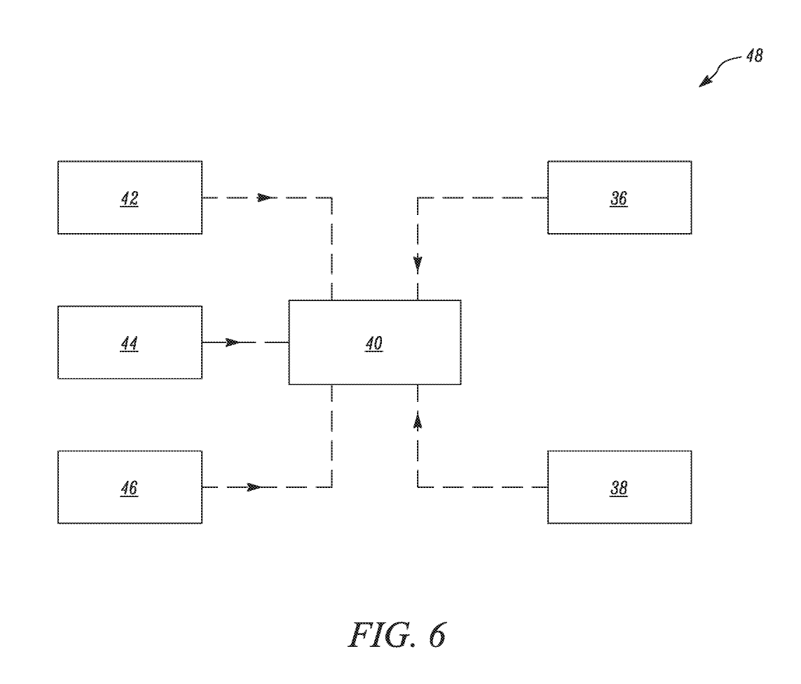

Referring to FIG. 6, the machine 10 includes a payload sensor 42, a speed sensor 44 and an inclination sensor 46. The payload sensor 42 may monitor aspects of the suspension of the machine 10 or embody a load cell. The payload sensor 42 may also embody an external input representing weight or another device or method known in the art for determining the weight of the payload and the machine 10. The payload sensor 42 may provide an output value of the payload in any of the preferred units. The payload sensor 42 provides signals to the controller 40 indicative of the payload being carried by the machine 10. The speed sensor 44 provides signals to the controller 40 indicative of the speed of the machine 10.

The inclination sensor 46 provides an inclination signal to the controller 40. The inclination signal is indicative of a grade/inclination of the ground surface on which the machine 10 is travelling. The inclination sensor 46 may embody an accelerometer, an inclinometer, or another sensor known in the art for determining incline, decline, change in elevation, slope, orientation, or grade of the ground surface. The inclination sensor 46 may also embody a global positioning system, an external input regarding grade at the current position of the machine 10, or an input from the operator of the machine 10. The grade may be measured as a percentage (%) grade of rise divided by run, with 0% grade being a flat slope of zero and a 100% grade being a steep slope of 1 foot rise over 1 foot run (1/1), or a 45 degree slope.

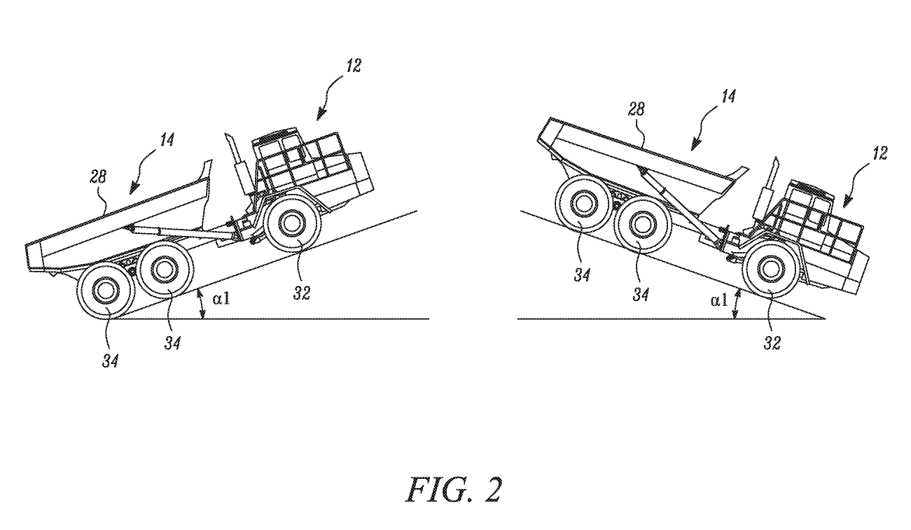

FIGS. 2-5 illustrate some possible orientations of the machine 10 and various angles related to the first and second frames 12, 14 during various operating configurations. FIG. 2 illustrates the machine 10 on an inclined ground surface having an inclination angle ‘α₁’ so that the first and second frames 12, 14 are in horizontal lateral alignment. The body 28 is in a lowered position.

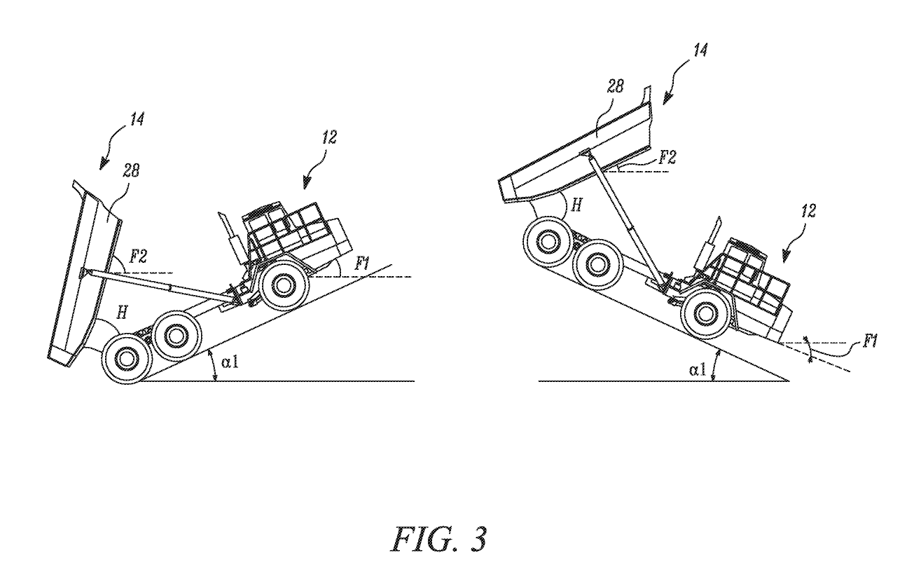

FIG. 3 illustrates the machine 10 travelling on an inclined ground surface having an inclination angle ‘α₁’. The body 28 is in the raised position. The first and second frames 12, 14 are in horizontal lateral alignment. A hoist angle ‘H’ is defined as an angle of the body 28 relative to the first frame 12. The hoist angle ‘H’ is calculated as a difference between an angle ‘F₁’ of the first frame 12 with the horizontal ground surface and an angle ‘F₂’ of the body 28 with the horizontal ground surface. The angles ‘F₁’ and ‘F₂’ are measured by the first and second sensor assemblies 36, 38 respectively. The controller 40 may receive the values of the angles ‘F₁’ and ‘F₂’ from the first and second sensor assemblies 36, 38 and calculate the value of the hoist angle ‘H’.

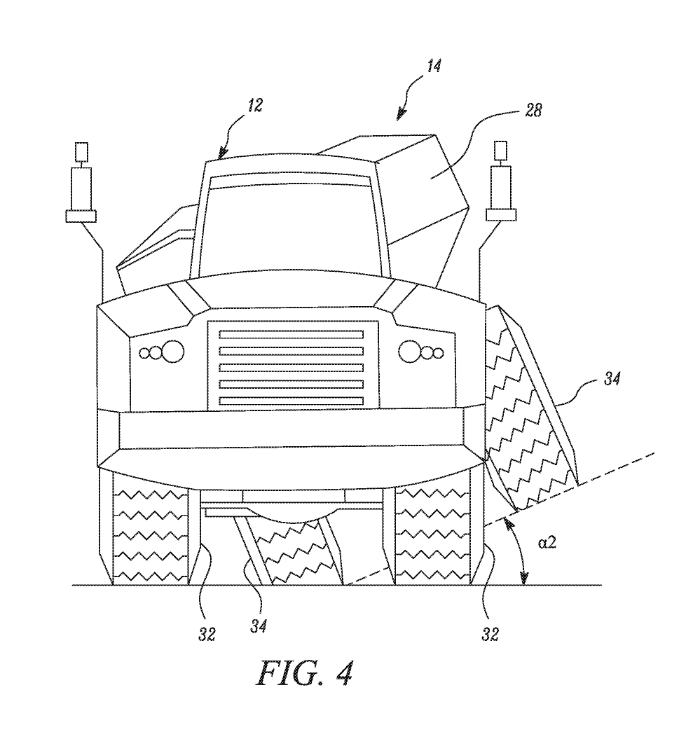

FIG. 4 illustrates the machine 10 with the body 28 in the lowered position. The first and second frames 12, 14 are in horizontal transverse alignment and horizontal lateral alignment. The body 28 is tilted sideways at an angle ‘α₂’ relative to the first frame 12. Center of Gravity (CG) of the machine 10 shifts upwards as well as sideways compared to its location when the machine 10 travels on a horizontal ground surface. A roll angle ‘R’ may be defined as the maximum allowable inclination angle for the first and second frames 12, 14 of the machine 10 to avoid roll over. The roll angle ‘R’ decreases in this orientation, due to increased risk of roll over. The roll angle ‘R’ decreases further if the body 28 is in the raised position.

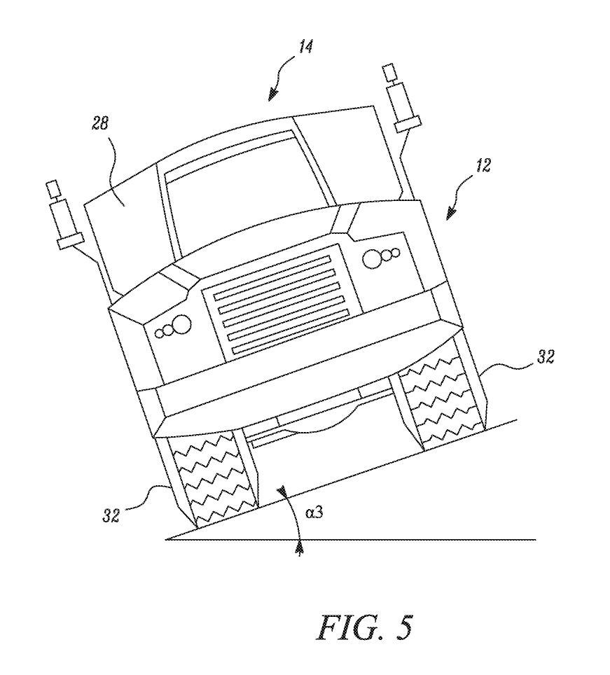

FIG. 5 illustrates the machine 10 travelling on a surface having a side slope ‘α₃’ relative to the horizontal ground surface. The body 28 is in the lowered position. The first and the second frames 12, 14 are in horizontal transverse alignment and horizontal lateral alignment. The location of the CG of the machine 10 again shifts upwards as compared to the machine 10 travelling on a horizontal ground surface. Thus, the value of the roll angle ‘R’ is again reduced. Similarly, the roll angle ‘R’ decreases further if the body 28 is in the raised position.

FIG. 6 shows a control system 48 for controlling the machine 10. The control system 48 includes the controller 40. The controller 40 receives signals from the speed sensor 44 indicative of the speed of the machine 10. The controller 40 receives signals from the payload sensor 42 indicative of the payload being carried by the machine 10. The controller 40 receives signals from the inclination sensor 46 indicative of the inclination of the ground surface. The controller 40 may also receive signals from the first and second sensor assemblies 36, 38 indicative of angles ‘F1’ and ‘F2’.

The controller 40 processes the various received signals to ensure safe operating conditions for the machine 10. The controller 40 processes the signals received from the speed sensor 44 and determines an operating speed of the machine 10. The controller 40 may have a pre-stored value of a threshold speed S_{MAX}. Operating speeds of the machine 10 higher than the threshold speed S_{MAX} may be termed as a higher speed range. Operating speeds of the machine 10 lower than the threshold speed S_{MAX} may be termed as normal speed range. The controller 40 compares the speed signal received from the speed sensor 44 with the threshold speed S_{MAX} and determines whether the machine 10 is operating in the higher speed range. If the machine 10 is operating in the higher speed range, the controller prevents the hoist operation. The controller 40 further generates a roll over warning in case the controller 40 prevents the hoist operation.

The controller 40 receives signals from the inclination sensor 46 indicative of the inclination of the ground surface while the machine 10 is travelling on an inclined surface as shown in FIGS. 2 and 3. The controller 40 may also receive signals from the first and second sensor assemblies 36, 38 indicative of angles ‘F₁’ and ‘F₂’. The controller 40 processes the signals received from the first and second sensor assemblies 36, 38 to calculate the value of the hoist angle ‘H’. The controller 40 may receive a hoist command from the operator of the machine 10 through the hoist control switch. The hoist command may indicate a desired value of the hoist angle ‘H’. The controller 40 receives signals from the inclination sensor 46 indicative of the inclination of the ground surface. The controller 40 may limit the hoisting of the machine 10 depending upon the inclination signal. For example, the machine 10 may be travelling on an inclined surface having an inclination angle ‘α₁’ as shown in FIG. 3. The operator may command the hoist operation. The value of the hoist angle ‘H’ may be provided as ‘H₁’ by the operator. The controller 40 may limit the hoist angle ‘H’ of the machine 10 and may allow hoisting of the body 28 only up to angle ‘H₁’−‘α₁’. The controller 40 further generates a roll over warning in case the controller 40 limits the hoist operation.

Referring back to FIGS. 4 & 5, the machine 10 is shown travelling on a side slope ‘α₃’. The controller 40 may receive signals from the inclination sensor 46 indicating the side slope of the ground surface. Additionally, the controller 40 also receives signals from the first and second sensor assemblies 36, 38 indicating the inclination ‘F₁’ of the first frame 12 and the inclination ‘F₂’ of the second frame 14 relative to the horizontal ground surface. The controller 40 compares the angles ‘F₁’ and ‘F₂’ with the roll angle ‘R’. The controller 40 may generate a roll over warning in case inclination of the first frame 12 or the second frame 14 exceeds the roll angle ‘R’. Further, the controller also receives signals indicative of the payload of the machine 10. As explained in the description of FIG. 5, the location of the CG of the machine 10 shifts upwards as compared to when the machine 10 is travelling on a horizontal ground surface. Further, a hoist operation in this orientation may cause the CG of the machine 10 to shift further upwards and that may cause the roll angle ‘R’ threshold to decrease. The controller 40 determines whether the hoisting of the second frame 14 to the desired angle can be completed without reaching the roll angle R. If the controller 40 identifies that the hoisting of the second frame 14 to the desired angle cannot be completed and the roll over event may occur, then the controller 40 prevents the hoisting of the second frame 14.

The roll over warning may be an audible signal provided to the operator in the operator cab 26. The roll over warning may be a video signal provided to the operator in the operator cab 26 on the display screen. The roll over warning may be provided by any other means without departing from the scope of the present disclosure. The roll over warning is active for a period for which the operational parameters of the machine 10 suggest a possible roll over condition.

The controller 40 may also provide a notification to the operator in the operator cab 26 in case the hoist is controlled by the controller 40. The operator may have an option to override the hoist prevention or limiting by the controller 40. For example, the operator may be prompted on the display screen to accept or reject the actions of the controller 40 to control the hoist operation. The operator may override the hoist control by selecting a center position of the hoist control switch and may manually reset the values for maximum allowable hoist angle.

However, in case the machine 10 encounters a roll over event, such as when the operator of the machine 10 continues to operate outside the safety limits as indicated by the warnings displayed by the controller 40 on the display screen, then the controller 40 may store the details of the roll over event in a database. For example, the controller 40 may store the date, time, name of the machine 10 and type etc., associated with the roll over event.

### INDUSTRIAL APPLICABILITY

The controller 40 of the present disclosure receives various signals indicative of operational parameters of the machine 10. The signals are indicative of the payload carried by the machine 10, the inclination of the ground surface, the speed of the machine 10 and the relative orientation of the first and second frames 12, 14. The controller 40 processes the various signals and generates warnings at various operating conditions. The warnings are indicative of a possible roll-over of the machine 10. The operator may judiciously follow/ignore the warnings and continue to safely operate the machine 10. The controller 40 provides inputs such as to prevent or limit the hoisting of the body 28 relative to the first frame 12. The warnings may be audible or may be displayed on the display screen in the operator cab 26. Further, in case the operator chose to ignore the warnings provided by the controller 40 and a roll over occurs, the controller 40 logs various parameters related to the roll over event in the memory of the controller 40.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of controlling an articulated machine, the articulated machine having a first frame and a second frame and travelling on a ground surface, the method comprising:
receiving, by a controller through a speed sensor, a speed signal indicative of a speed of the articulated machine;
receiving, by the controller through an inclination sensor, an inclination signal indicative of an inclination of the ground surface;
receiving, by the controller through a payload sensor, a payload signal indicative of a payload carried by the articulated machine; and
controlling, using the controller, a hoisting of the second frame with respect to the first frame based on at least one of the speed signal, the inclination signal and the payload signal.

2. The method of claim 1, wherein controlling the hoisting comprises preventing the hoisting of the second frame if the speed of the articulated machine is greater than a predetermined threshold speed, the predetermined threshold speed is defined to prevent a rolling over of the articulated machine.

3. The method of claim 1, wherein controlling the hoisting comprises limiting the hoisting of the second frame based on the inclination of the ground surface.

4. The method of claim 1, wherein controlling the hoisting comprises preventing the hoisting of the second frame based on a relative position of the second frame with respect to the first frame and the payload carried by the articulated machine.
